(19) United States
(12) Patent Application Publication
(10) Pub. No.: US 2026/0051305 A1
(43) Pub. Date: Feb. 19, 2026

(54) Hardware for Musical Instrument Support Stands

(71) Applicant: Randall May International, Inc., Irvine, CA (US)

(72) Inventor: Randall L. MAY, Irvine, CA (US)

(21) Appl. No.: 19/300,434

(22) Filed: Aug. 14, 2025

Related U.S. Application Data
(60) Provisional application No. 63/683,623, filed on Aug. 15, 2024.

(51) Int. Cl. G10D 13/10

(52) U.S. Cl. CPC G10D 13/28

(57) ABSTRACT

An adjustable stop for an instrument support stand includes at least one end configured to couple with a mechanical assist positioned interior to a tube of the instrument support stand. The adjustable stop also includes at least one side defining an operative diameter that is adjustable to frictionally engage and disengage the interior of the tube upon actuation by a user. By way of the frictional engagement and disengagement the adjustable stop is repositionable within the interior of the tube so as to adjust a deployment range of the mechanical assist.

### CROSS REFERENCE TO RELATED APPLICATION

This application claims priority to Provisional Application No. 63/683,623 filed Aug. 15, 2024, the entire contents of which are expressly incorporated by reference.

This application is related to application Ser. No. 14/497,923 filed Sep. 26, 2014, which is now U.S. Pat. No. 9,863,573, the entire contents of which are expressly incorporated by reference.

This application is also related to application Ser. No. 15/826,547 filed Nov. 29, 2017, which is now U.S. Pat. No. 10,167,994, the entire contents of which are expressly incorporated by reference.

### BACKGROUND AND SUMMARY

The invention relates to improvements to hardware for support stands for musical instruments.

Instrument support stands are known from at least the following U.S. Pat. Nos. 5,072,910; 7,438,266; 7,588,228; 7,703,725; 7,718,878; 9,863,573; 9,881,595; and 10,167,994. It is also known to manufacture such support stands with mechanical assists interior to the support stands. However, many instrument support stands are not manufactured with mechanical assists. It is also known to plug the end of a pipe with a plug that includes a metallic cone or an elastomer washer that is squeezed to expand and seal the plug within the inside diameter of the pipe. Such plugs are not easily repositioned along the interior length of the pipe.

It is an object of the invention to provide systems, methods and devices that permit the easy and effective retrofitting of mechanical assists to instrument support stands that lack mechanical assists. It is also an object of the invention to provide one or more adjustable stops that can be positioned on the stand to adjust the deployment of mechanical assists. For example, an upper stop and a lower stop can be positioned in order to raise/lower a portion of the stand so that the instrument supported thereon is adjusted to/from a preferred playing position of the performer. At least the range of the mechanical assist can be accordingly adjusted and a variety of stand sizes may be fit by the invention.

In addition, instrument support stands that are not manufactured with internal mechanical assists generally include obstructions (e.g., screws, rivets, etc.) that protrude interior to the support stands and therefore prohibit the retrofit addition of an after-market mechanical assist. It is an additional object of the invention to provide systems, methods and devices that permit the adjustable stops and/or mechanical assists to bypass such obstructions.

It is also an object of the invention to provide systems, methods and devices that permit the simple substitution of mechanical assists. For example, mechanical assists with different work force ratings can be substituted. It is also an object of the invention to allow for easy removal of the mechanical assists for separate storage and/or transportation. It is also an object of the invention to provide systems, methods and devices that self-center the mechanical assists and improve vertical alignment within the support stands.

Various additional objects, features, aspects and advantages of the present invention will become more apparent from the following detailed description of preferred embodiment of the invention, along with the accompanying drawings in which like numbers represent like components.

### BRIEF DESCRIPTION OF THE DRAWINGS

FIGS. 1-4 illustrate aspects of a mechanical assist support stop according to at least one embodiment;

FIG. 5A illustrates aspects of a mechanical assist support stop according to at least one embodiment;

FIG. 5B illustrates aspects of a mechanical assist support stop according to at least one embodiment;

FIG. 6A illustrates aspects of a mechanical assist support stop according to at least one embodiment;

FIG. 6B illustrates aspects of a mechanical assist support stop according to at least one embodiment;

FIG. 7 illustrates aspects of a mechanical assist support stop according to at least one embodiment;

FIG. 8 illustrates aspects of a percussion instrument stand equipped with a mechanical assist and support stops according to at least one embodiment;

FIGS. 9-10 illustrate aspects of a retrofit mechanical assist instrument support system according to at least one embodiment;

### DETAILED DESCRIPTION

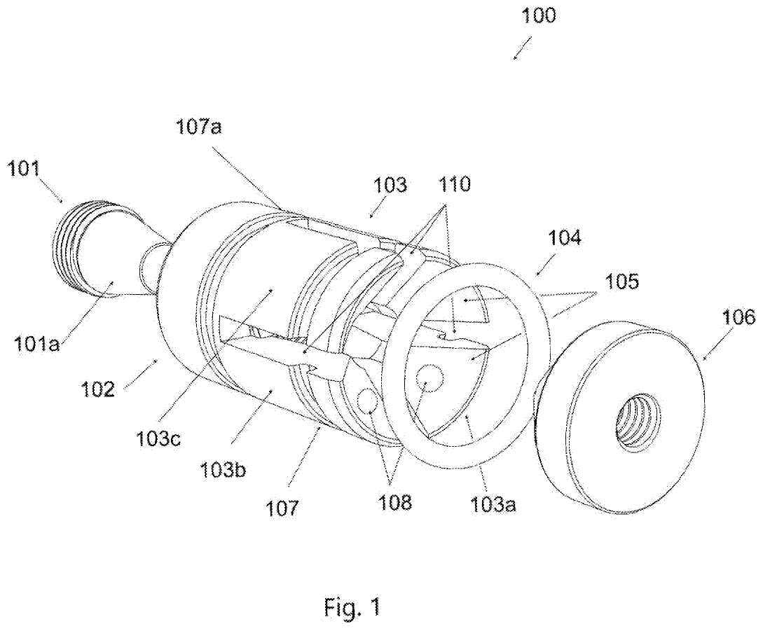

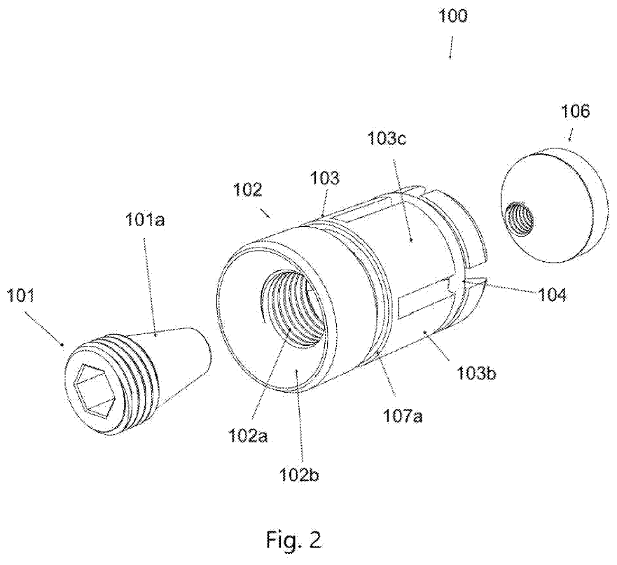

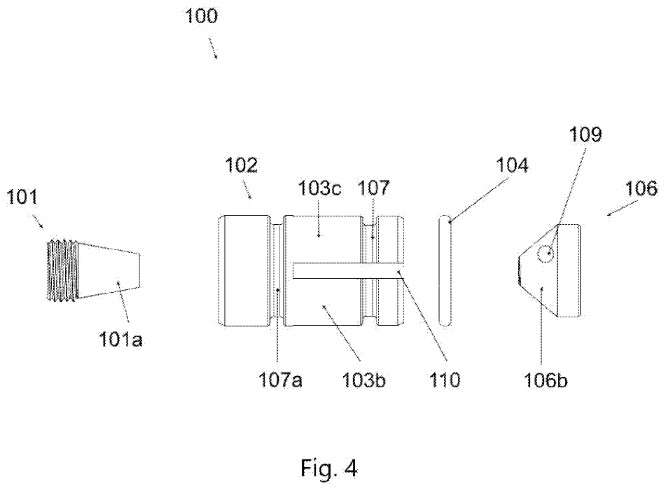

FIGS. 1-4 illustrate aspects of a mechanical assist support stop 100 according to at least one embodiment. The mechanical assist support stop 100 (sometimes referred to herein as the “support stop” or “stop”) has support stop capsule 102 that houses a drive screw 101. The drive screw 101 has a conical body 101a that when screwed inward contacts flexure prongs 103 (103a, 103b, 103c) of the support stop capsule 102. The flexure prongs 103 have separating relief voids 110 allowing the flexure prongs 103 to expand and/or retract when the drive screw 101 contacts the flexure prongs 103 via the inward screwing action.

The flexure prongs 103 further have respective pockets 107 configured to collectively seat and secure an elastomer O-ring 104. The O-ring provides drag to the support stop 100 and resists rotation when the support stop 100 is being locked into position.

The support stop capsule 102 may also include a circumferential undercut relief channel 107a at the base of flexure prongs 103. The relief channel may allow the flexure prongs 103 to flex at the undercut relief channel 107a easily and without fracturing the base of the prongs 103. The relief channel 107a can further be utilized as an additional O-ring pocket to provide additional drag and/or rotation resistance. The O-ring 104 may be of round, square, rectangle, or any other shape.

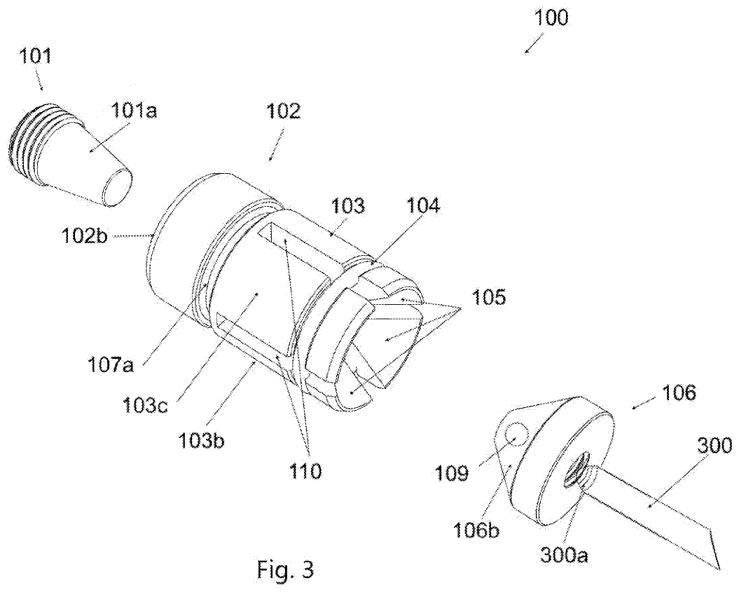

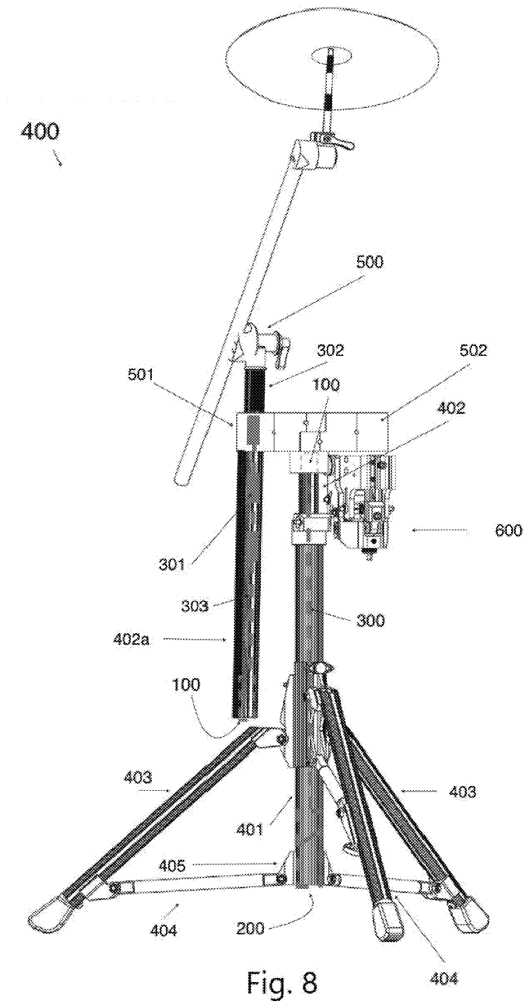

As shown in FIG. 3, in at least one embodiment, the support stop capsule 102 includes at least one convex polar end 102b, 105 configured to mate with a conical plug 106. The conical plug 106 may be connected to a mechanical assist 300, which may be gas spring. The mechanical assist 300 may have threaded polar ends 300a to receive the conical plug 106. The conical plug 106 may further have an alignment taper 106b that gravity seats into the convex polar end 102b (and similarly into the convex polar end 105) to support and align the mechanical assist 300 within instrument support stand 400 (FIG. 8). The conical plug 106 and the associated polar end 102b or 105 need not be conically shaped, but may be of any male/female geometry to seat and align the mechanical assist 300.

In at least one embodiment, the conical plug 106 and at least one of the convex polar ends 102b, 105 are magnetically attracted to one another so as to be secured in place. For example, the conical plug 106 and at least one of the convex polar ends 102b, 105 may be constructed of ferrous material. Alternatively, one or more magnets 108, 109 may be embedded within the conical plug 106 and the support stop capsule 102. FIGS. 1 and 3 illustrate exemplary embodiments with the magnets 108 and 109 press fit into the flexure prongs 103 at respective convex pockets 105 so as to magnetically couple to plug 106 via magnet 109. However, it will be understood that the magnets 108, 109 may be located at other locations sufficient to provide the desired magnetic securing.

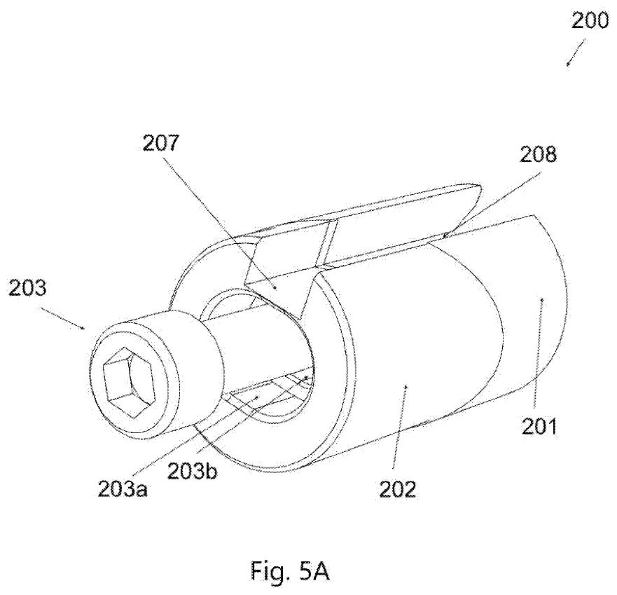

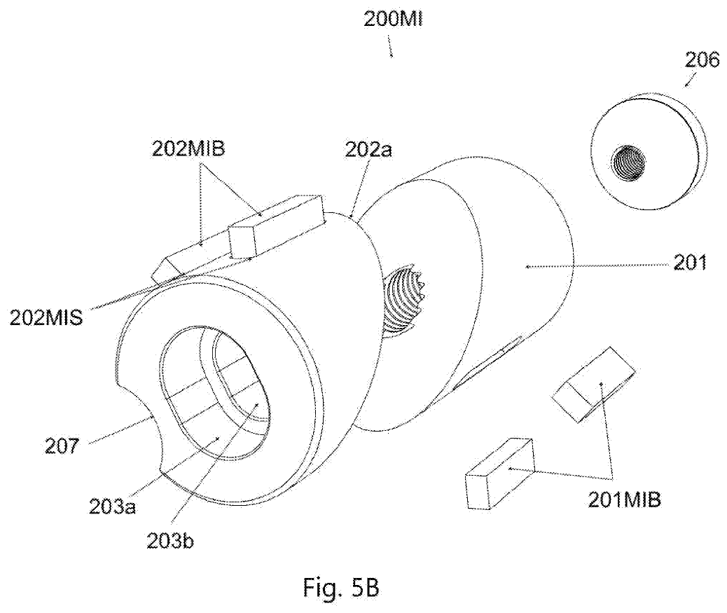

FIGS. 5A, 6A and 7-9 illustrate the adjustable stop 200 comprising a first portion 201 and a second portion 202 according to at least one embodiment. The first portion 201 and second portion 202 houses a draw/drive screw 203 that locks the adjustable stop 200 into place within a tube 401 of the instrument support stand 400 (FIG. 8). The adjustable stop 200 is locked into place via draw/drive screw 203. The screw/unscrew action of the draw/drive screw 203 cause mitered sections 202a, 202b to offset from a central axis thereby pressing against an inside wall of the tube 401 so as to lock into a friction grip position. The draw/drive screw 203 is free to move laterally via channels 203a and 203b to travel with the offset mitered sections 202a and 202b.

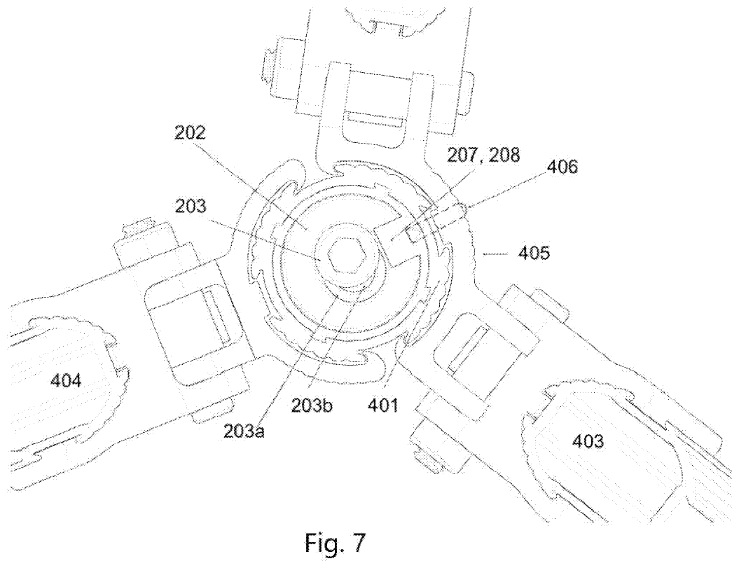

The adjustable stop 200 may be configured to clear obstructions 406 (e.g., rivets, screws, etc.) (FIG. 7). In particular, the first portion 201 and/or the second portion 202 may include longitudinal channels 207, 208 that are sized, shaped and positioned to clear the obstructions 406 inside of tube 401 (FIG. 7). It is further contemplated that adjustable stops 100, 200 can be of a non-circular shape so as to fit other tubing shapes i.e. square, rectangular, oval, etc. Such non-circular shapes (i.e., cross-sectional shape) may further configure the adjustable stop 200 to clear obstructions 406.

In at least one embodiment, the first portion 201 and the second portion 202 may include an inlay of friction adding material (e.g., rubber or the like) opposite the longitudinal channels 207, 208 so as to provide additional drag and resist rotation when locking into position.

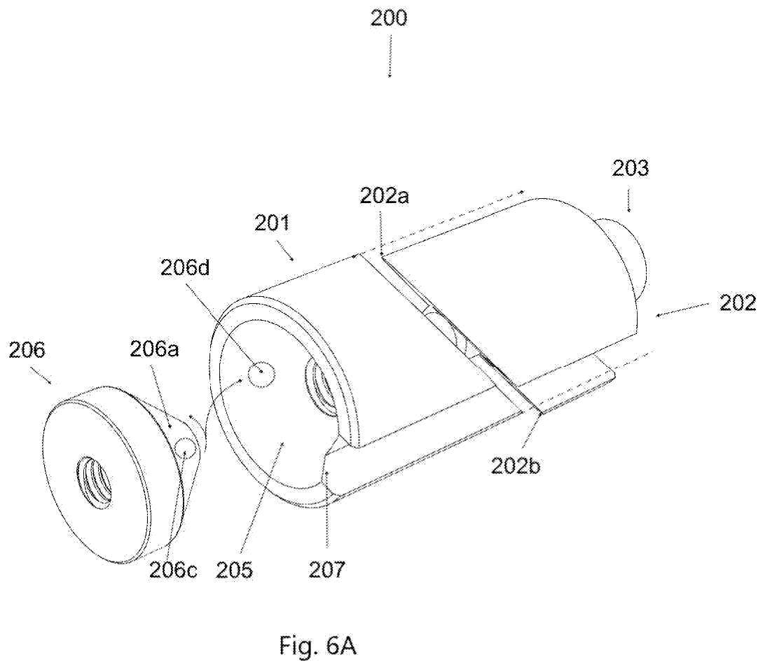

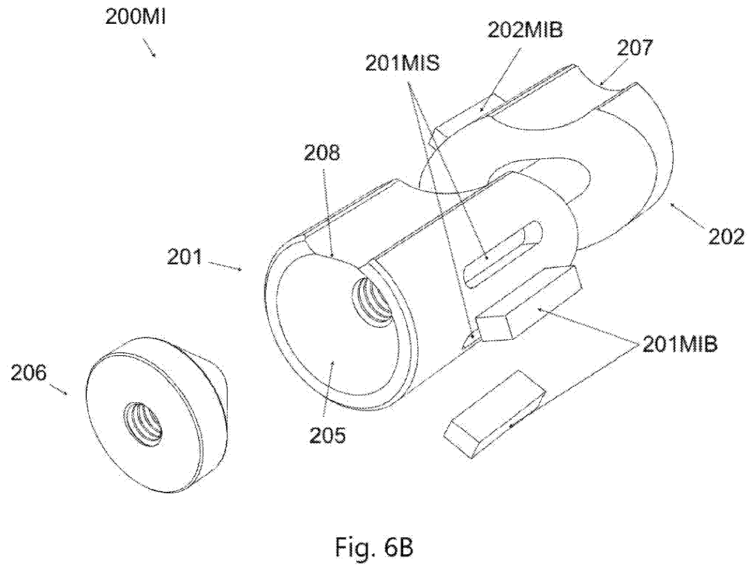

FIGS. 5B and 6B illustrate the adjustable stop 200MI with one or more modular inserts 201MIB, 202MIB according to at least one embodiment. The modular inserts may be configured to expand an operative diameter of the adjustable stop 200MI, including at the first portion 201 and/or the second portion 202.

The adjustable stop 200MI may be provided with one or more pocket slots 201MIS, 202MIS configured to accept and hold therein the modular inserts 201MIB, 202MIB. The modular inserts 201MIB, 202MIB may be configured to be inserted into and held within the pocket slots 201MIS, 202MIS. For example, the modular inserts 201MIB, 202MIB may be frictionally held within the corresponding pocket slots 201MIS, 202MIS. Other methods of holding the modular inserts 201MIB, 202MIB within the corresponding pocket slots 201MIS, 202MIS may be utilized without departing from the scope of the invention, including at least adhesive, magnetic, etc., holding. The modular inserts 201MIB, 202MIB may be provided in different sizes (e.g., radial height relative to central axis of the stop 200MI) so as to expand the operative diameter of the adjustable stop 200 MI to varying extents and thereby enable the adjustable stop to be sized to fit within tubes of varying inner diameters.

FIG. 8 illustrates a percussion instrument support stand 400 according to at least one embodiment. The support stand 400 includes a mechanical assist 300 positioned between an upper support stop 100 and a lower support stop 200. It will be understood that, while the adjustable support stop 100 (discussed with reference to FIGS. 1-4) is described herein as the upper support stop, the upper support stop may instead be adjustable support stop 200 (discussed with reference to FIGS. 5-7), and vice versa with respect to the lower support stop.

The lower support stop 200 may be secured inside a lower base tube 401, whereas the upper support stop 100 may be secured inside a telescoping support tube 402. The telescoping tube 402 may terminate at knuckles 501, 502. The instrument supports may be configured to directly or indirectly support the instrument 600. Exemplary instrument stands are described in: U.S. Pat. No. 10,249,273, filed Jan. 16, 2018; U.S. Pat. No. 10,818,276, filed Mar. 4, 2019; U.S. Pat. No. 11,335,307, filed Sep. 24, 2020; the entire contents of each of which are hereby incorporated by reference.

As shown, at least one knuckle 501 engages a support tube 402a on which the instrument is supported above the surface on which the stand 400 rests. In some embodiments, the support tube 402a in turn includes a support-tube-based mechanical assist 301 within shaft 303. As described herein, the conical plug 106 may be coupled to the mechanical assist 301 and may be supported on adjustable support stop 100 that is positioned interior to support tube 402a. The mechanical assist 301 may include an upper body 302 having a treaded stud 300a that couples to an instrument support 500. The support tube 402a may have an inner diameter that is sufficient to allow the upper body 302 to telescopically extend/retract inside the support tube 402a.

In at least one embodiment, the plug 206 and associated capsule receiving the polar end 205 may be of any male/female geometry to seat and align the mechanical assist. It is further contemplated that the polar end 205 may be of ferrous material, with a least one of the polar end 205 and the plug 206 magnetized to attract the other so as to secure them together. A single or plurality of magnets 206c, 206d may be embedded in the plug 206 and/or the capsule 201.

Turning back to FIG. 6A, the capsule 200 may have a convex polar end 205 configured to mate with the conical plug 206 that is coupled to the mechanical assist 300. The mechanical assist 300 may have threaded polar ends 300a configured to receive the conical plug 206 threaded into a threaded portion 206c. The conical plug may have an alignment taper 206a that gravity seats the conical plug 206 into the convex polar end 205 to support and align the mechanical assist 300 within the instrument support stand 400.

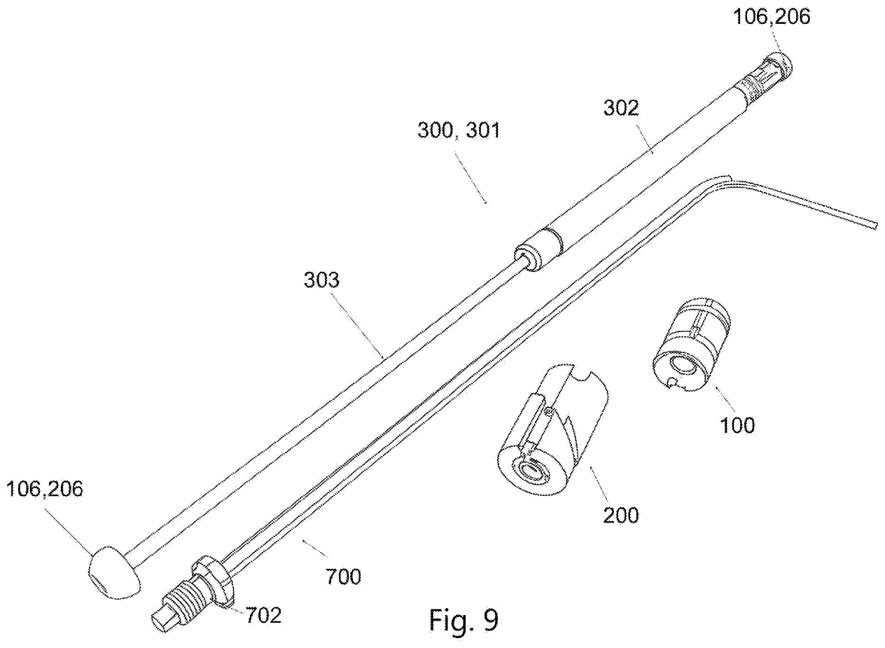

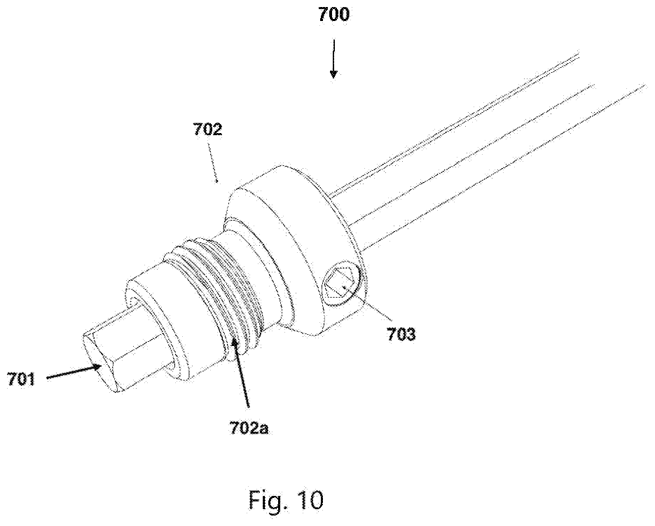

FIGS. 9 and 10 illustrate aspects of exemplary systems according to at least one embodiment. The systems may include one or more of the previously described components enabling the retrofitting of the mechanical assist 300 within the support stand 400. In some embodiments, the system includes a positioning tool 700 configured to position the adjustable stop 100, 200 within the support stand 400.

The positioning tool 700 may include a hex drive end 701 configured to engage with the draw/drive screw 203, 101. The positioning tool 700 may include a repositioning adaptor 702 that is configured to be secured in place via a set screw 703. The adaptor 702 may be configured to be repositioned longitudinally when not in use and positioned at end of tool 700 when in use. When the adaptor 702 is positioned at end of the tool 700 to engage/connect with the support stop 100, the threaded end 702a screws into threaded cavity 102a. The threaded cavity 102a may have sufficient length to allow the conical drive screw 101 to be loosened, thereby releasing the flexure pongs 103-103c to a non-compression state on inside tube. This permits repositioning of the support stop 100. The O-ring 104 provides drag on insertion to resist stop 100 from turning when the drive tool 700 is rotated.

It will be understood that the principles of the invention may similarly be applied to one or more support legs 403 of the stand 400 so as to retroactively provide the stand 400 with the ability to self-level.

The features described above are considered novel over the prior art of record and are considered vital to the preferred operation of at least one aspect of the invention and to the achievement of the objectives of the invention. The words used in this specification to describe the exemplary embodiments are to be understood not only in the sense of their commonly defined meanings, but also to include any special definition with regard to structure, material or acts that would be understood by one of ordinary skilled in the art to apply in the context of the entire disclosure.

The definitions of the words or drawing elements described herein are meant to include not only the combination of elements which are literally set forth, but all equivalent structures, materials or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim without departing from the scope of the invention.

Changes from disclosed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

What is claimed is:

1. An adjustable stop for an instrument support stand, comprising:
at least one end configured to couple with a mechanical assist positioned interior to a tube of the instrument support stand; and
at least one side defining an operative diameter that is adjustable to frictionally engage and disengage the interior of the tube upon actuation by a user, whereby via the frictional engagement and disengagement the adjustable stop is repositionable within the interior of the tube so as to adjust a deployment range of the mechanical assist.

2. The adjustable stop of claim 1, wherein the at least one end includes a plurality of flexure prongs.

3. The adjustable stop of claim 2, wherein the plurality of flexure prongs each include a respective relief void, and wherein the relief voids collectively hold an o-ring positioned therein.

4. The adjustable stop of claim 1, wherein the adjustable stop comprises: a first mitered portion and a second mitered portion configured to axially offset so as to adjust the operative diameter.

5. The adjustable stop of claim 1, wherein the adjustable stop includes an actuation mechanism for actuating the frictional engagement and disengagement, and wherein the actuation mechanism includes a drive screw located opposite the at least one end.

6. The adjustable stop of claim 1, wherein the at least one end couples with the mechanical assist via a conical plug attached to the mechanical assist.

7. The adjustable stop of claim 1, wherein the at least one side includes at least one longitudinal channel configured to clear one or more obstructions within the interior of the tube.

8. The adjustable stop of claim 7, wherein the at least one longitudinal channels is formed from two or more protrusions extending from the at least one side.

9. The adjustable stop of claim 1, wherein each of the protrusions comprises a modular insert removably inserted into a receiving slot on the at least one side.

10. A system for retrofitting an instrument support stand with a mechanical assist, comprising:
adjustable stop, wherein the adjustable stop includes:
at least one end configured to couple with the mechanical assist positioned interior to a tube of the instrument support stand, and
at least one side defining an operative diameter that is adjustable to frictionally engage and disengage the interior of the tube upon actuation of an actuation mechanism by a user, whereby via the frictional engagement and disengagement the adjustable stop is repositionable within the interior of the tube so as to adjust a deployment range of the mechanical assist: and
a positioning tool configured to engage with the actuation mechanism so as to allow the user to actuate the actuation mechanism.

11. The adjustable stop of claim 10, wherein the actuation mechanism includes a drive screw located opposite the at least one end.

12. The adjustable stop of claim 10, wherein the at least one end includes a plurality of flexure prongs.

13. The adjustable stop of claim 12, wherein the plurality of flexure prongs each include a respective relief void, and wherein the relief voids collectively hold an o-ring positioned therein.

14. The adjustable stop of claim 10, wherein the adjustable stop comprises: a first mitered portion and a second mitered portion configured to axially offset so as to adjust the operative diameter.

15. The adjustable stop of claim 10, wherein the at least one end couples with the mechanical assist via a conical plug attached to the mechanical assist.

16. The adjustable stop of claim 10, wherein the at least one side includes at least one longitudinal channel configured to clear one or more obstructions within the interior of the tube.

17. The adjustable stop of claim 16, wherein the at least one longitudinal channel is formed from two or more protrusions extending from the at least one side.

18. The adjustable stop of claim 17, wherein each of the protrusions comprises a modular insert removably inserted into a receiving slot on the at least one side.
